(19) United States
(12) Patent Application Publication
(10) Pub. No.: US 2007/0020007 A1
(43) Pub. Date: Jan. 25, 2007

(54) Image forming apparatus and auto document feeder providing enhanced usability

(76) Inventor: Terumitsu Azuma, Nagoya City (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/488,733

(22) Filed: Jul. 19, 2006

(30) Foreign Application Priority Data
Jul. 19, 2005 (JP) 2005-208326
Feb. 22, 2006 (JP) 2006-044940

(51) Int. Cl. G03G 15/00

(52) U.S. Cl. 399/367

(57) ABSTRACT

An image forming apparatus includes an auto document feeder, a scanner, a paper tray, and an image forming mechanism. The auto document feeder feeds an original sheet having an image and includes an original tray configured to load the original sheet having the image and a detecting mechanism configured to detect the original sheet set on the original tray. The detecting mechanism includes a terminal including a plane surface disposed to form a predetermined angle with respect to a sheet conveyance direction. The scanner scans the image on the original sheet fed by the auto document feeder to create image data. The paper tray supplies a recording medium. The image forming mechanism forms an image on the recording medium supplied from the paper tray with a developer according to the image data created by the scanner.

### BACKGROUND

1. Field of Invention

Exemplary aspects of the present invention relate to an image forming apparatus and an auto document feeder, and more particularly to an image forming apparatus and an auto document feeder providing enhanced usability.

2. Description of the Related Art

A related art image forming apparatus, such as a copying machine, a facsimile machine, an image scanner, or a multifunction printer, scans an image on an original sheet to create image data. The image data is sent to other facsimile machine or a personal computer, or is stored in the image forming apparatus to form an image on a recording medium with a developer according to the image data.

The image on the original sheet is scanned through an exposure glass generally disposed on top of a scanner of the image forming apparatus. The original sheet to be scanned is fed to the exposure glass by an auto document feeder disposed above the exposure glass. When the image on the original sheet has been scanned, the auto document feeder feeds the original sheet out of the exposure glass, and then feeds a next original sheet to be scanned to the exposure glass.

One example of the auto document feeder includes a sheet size checker, an original tray, and a plurality of recycle levers. The sheet size checker detects the size of an original sheet fed from the original tray. The plurality of recycle levers detect that the last sheet of original sheets set on the original tray has been fed. The plurality of recycle levers are disposed along a sheet conveyance direction and one of the plurality of recycle levers is selected according to the size of the original sheet detected by the sheet size checker. However, the plurality of recycle levers have a complex structure, resulting in increased production costs.

Another example of the auto document feeder includes an optical sensor disposed on an original tray to detect a tail edge of an original sheet set on the original tray. When the optical sensor detects the tail edge of the last sheet of original sheets set on the original tray, the optical sensor outputs a detection signal to control feeding of a recording sheet. However, light disturbance or an obstacle above the optical sensor may cause erroneous detection of the optical sensor.

FIG. 1 illustrates yet another example of the auto document feeder, that is, an auto document feeder 1 including an original tray 2, a fan-shaped flag sensor 6, and adjusters 8. The flag sensor 6 is disposed on the original tray 2 and detects an original sheet D set on the original tray 2. When the flag sensor 6 detects the last sheet of original sheets D set on the original tray 2, feeding of a recording sheet is controlled based on the detection. The adjusters 8 are disposed both ends of the original tray 2 in a direction perpendicular to a sheet conveyance direction and are moved in directions W and X to guide the original sheet D to be properly fed in the sheet conveyance direction. The flag sensor 6 is disposed parallel to the sheet conveyance direction and on a substantially center portion between the adjusters 8 in the direction perpendicular to the sheet conveyance direction. When the original sheet D is set in a direction Y or Z and the adjusters 8 are moved to guide the original sheet D, the original sheet D may hit the flag sensor 6 and thereby may be caught by the flag sensor 6.

### SUMMARY

This specification describes below an image forming apparatus according to an exemplary embodiment of the invention. In one aspect of the present invention, the image forming apparatus includes an auto document feeder, a scanner, a paper tray, and an image forming mechanism. The auto document feeder is configured to feed an original sheet having an image and includes an original tray configured to load the original sheet having the image and a detecting mechanism configured to detect the original sheet set on the original tray. The detecting mechanism includes a terminal including a plane surface disposed to form a predetermined angle with respect to a sheet conveyance direction. The scanner is configured to scan the image on the original sheet fed by the auto document feeder to create image data. The paper tray is configured to supply a recording medium. The image forming mechanism is configured to form an image on the recording medium supplied from the paper tray with a developer according to the image data created by the scanner.

This specification further describes an auto document feeder according to one exemplary embodiment of the invention. In one aspect of the present invention, the auto document feeder is configured to feed an original sheet having an image and includes an original tray and a detecting mechanism including a terminal. The original tray is configured to load the original sheet having the image. The detecting mechanism is configured to detect the original sheet set on the original tray. The terminal includes a plane surface disposed to form a predetermined angle with respect to a sheet conveyance direction.

### BRIEF DESCRIPTION OF THE DRAWINGS

A more complete appreciation of the invention and the many attendant advantages thereof will be readily obtained as the same becomes better understood by reference to the following detailed description when considered in connection with the accompanying drawings, wherein:

FIG. 1 is a top view of a related art auto document feeder;

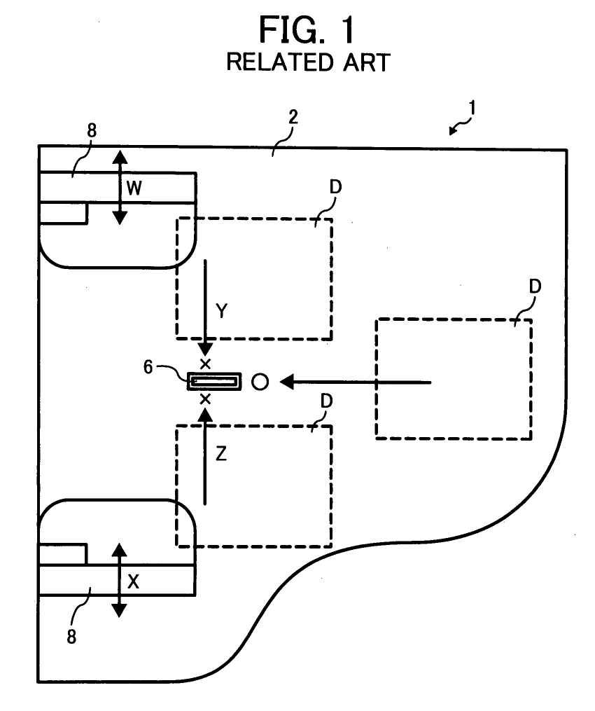

FIG. 2 is a sectional view of an image forming apparatus according to an exemplary embodiment of the present invention;

FIG. 3 is a sectional view of an auto document feeder of the image forming apparatus shown in FIG. 2;

FIG. 4 is a perspective view of the auto document feeder shown in FIG. 3;

FIG. 5 is a perspective view of a detecting feeler of the auto document feeder shown in FIG. 3;

FIG. 6 is a top view of the auto document feeder shown in FIG. 3;

FIG. 7 is a top view of the auto document feeder shown in FIG. 6 when an original sheet is inserted from a specific direction;

FIG. 8 is a top view of the auto document feeder shown in FIG. 6 when an original sheet is inserted from another direction;

FIG. 9 is a top view of the auto document feeder shown in FIG. 6 when an original sheet is inserted from yet another direction; and

FIG. 10 is a top view of the auto document feeder shown in FIG. 6 when an original sheet of a smallest size is inserted.

### DETAILED DESCRIPTION OF THE PREFERRED EMBODIMENTS

In describing the exemplary embodiments illustrated in the drawings, specific terminology is employed for the sake of clarity. However, the disclosure of this specification is not intended to be limited to the specific terminology so selected and it is to be understood that each specific element includes all technical equivalents that operate in a similar manner.

Referring now to the drawings, wherein like reference numerals designate identical or corresponding parts throughout the several views, an image forming apparatus 10 according to a first exemplary embodiment of the present invention is explained.

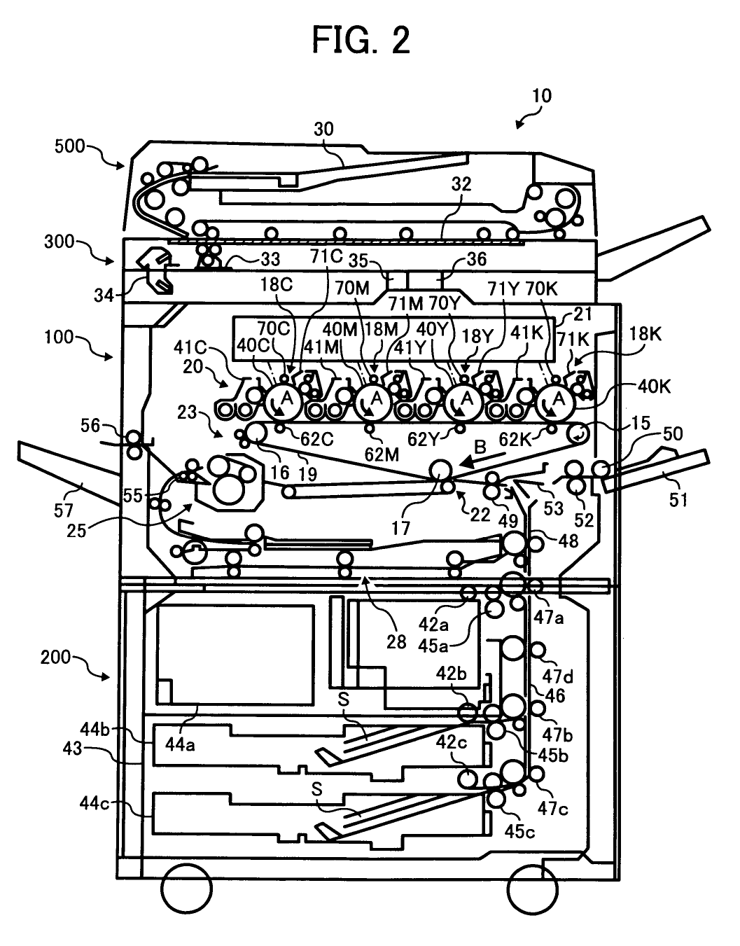

As illustrated in FIG. 2, the image forming apparatus 10 includes an auto document feeder 500, a scanner 300, a paper tray unit 200, and a body 100.

The image forming apparatus 10 includes a copying machine, a facsimile machine, an image scanner, a multifunction printer including copying, printing, scanning, and facsimile functions, or the like. According to this non-limiting exemplary embodiment of the present invention, the image forming apparatus 10 functions as a color copying machine for scanning an image on an original sheet to create image data and forming a color image on a recording sheet according to the image data.

The auto document feeder 500 is disposed on the scanner 300 and is configured to feed an original sheet to the scanner 300. The scanner 300 is disposed under the auto document feeder 500 and on the body 100, and is configured to scan an image on the original sheet to create image data and to send the image data to the body 100. The paper tray unit 200 is disposed under the body 100 and is configured to load recording sheets S and to feed the recording sheets S one by one to the body 100. The body 100 is disposed under the scanner 300 and on the paper tray unit 200, and is configured to perform image processing to form an image on the recording sheet S sent from the paper tray unit 200 according to the image data created by the scanner 300.

The auto document feeder 500 includes an original tray 30. The scanner 300 includes an exposure glass 32, a first traveler 33, a second traveler 34, a lens 35, and a scanning sensor 36. The auto document feeder 500 is hinged on a top of the scanner 300 so as to be lifted from and lowered onto the top of the scanner 300. A user inserts an original sheet having an image to be scanned into the original tray 30. Otherwise, the user lifts the auto document feeder 500 to place the original sheet onto the exposure glass 32. The user then lowers the auto document feeder 500 so that the auto document feeder 500 presses the original sheet placed on the exposure glass 32.

When the user presses a start button on a control panel (not shown) of the image forming apparatus 10, the scanner 300 starts scanning the image on the original sheet. However, when the original sheet is inserted in the original tray 30, the original sheet is fed onto the exposure glass 32 before the scanner 300 starts scanning. Specifically, a driving mechanism (not shown) moves the first traveler 33 and the second traveler 34. A light source (e.g., a lamp) of the first traveler 33 emits light onto the original sheet via the exposure glass 32. A mirror of the first traveler 33 deflects the light reflected by the original sheet toward the second traveler 34. Mirrors of the second traveler 34 further deflect the light toward the lens 35. The lens 35 irradiates the deflected light into the scanning sensor 36. The scanning sensor 36 includes a CCD (charge-coupled device) and converts the light into an electric signal to create image data.

The paper tray unit 200 includes a paper bank 43, feeding rollers 42a, 42b, and 42c, separating rollers 45a, 45b, and 45c, a conveyance path 46, and conveying rollers 47a 47b, 47c, and 47d. The paper bank 43 includes paper trays 44a, 44b, and 44c.

The paper trays 44a, 44b, and 44c are layered in the paper bank 43 and load recording sheets S. When the user presses the start button on the control panel of the image forming apparatus 10, one of the paper trays 44a, 44b, and 44c is automatically selected according to the size and orientation of the original sheet detected through the exposure glass 32 or manually selected according to the size and orientation that the user has specified on the control panel of the image forming apparatus 10. Thus, one of the feeding rollers 42a, 42b, and 42c rotates to feed an uppermost recording sheet S of the recording sheets S loaded on the paper tray 44a, 44b, or 44c. The separating roller 45a, 45b, or 45c separates the uppermost recording sheet S from other recording sheet S when a plurality of recording sheets S are fed by the feeding roller 42a, 42b, or 42c and feeds only the uppermost recording sheet S toward the conveying roller 47a, 47b, or 47c. The conveying rollers 47a, 47b, 47c, and/or 47d feed the recording sheet S through the conveyance path 46 up toward the body 100.

The body 100 includes a conveyance path 48, a registration roller 49, a bypass tray 51, a feeding roller 50, a separating roller 52, a conveyance path 53, a tandem image forming unit 20, an exposure unit 21, an intermediate transfer belt 19, support rollers 15, 16, and 17, first transferors 62C, 62M, 62Y, and 62K, a second transferor 22, a belt cleaner 23, a fixing unit 25, a switching nail 55, an output roller 56, an output tray 57, and a reverse unit 28.

The tandem image forming unit 20 includes image forming units 18C, 18M, 18Y, and 18K. The image forming unit 18C includes a photoconductor 40C, a charger 70C, a development unit 41C, and a cleaner 71C. The image forming unit 18M includes a photoconductor 40M, a charger 70M, a development unit 41M, and a cleaner 71M. The image forming unit 18Y includes a photoconductor 40Y, a charger 70Y, a development unit 41Y, and a cleaner 71Y. The image forming unit 18K includes a photoconductor 40K, a charger 70K, a development unit 41K, and a cleaner 71K.

The bypass tray 51 may load recording sheets S including thick paper and a postcard. When the recording sheets S are placed on the bypass tray 51, the bypass tray 51 is automatically selected. When the user presses the start button on the control panel of the image forming apparatus 10, the feeding roller 50 rotates to feed an uppermost recording sheet S of the recording sheets S loaded on the bypass tray 51. The separating roller 52 separates the uppermost recording sheet S from other recording sheet S when a plurality of recording sheets S are fed by the feeding roller 50 and feeds only the uppermost recording sheet S toward the conveyance path 53. The recording sheet S is conveyed through the conveyance path 53 and stops when contacting the registration roller 49. The recording sheet S fed by the conveying rollers 47a, 47b, 47c, and/or 47d and conveyed through the conveyance path 48 also stops when contacting the registration roller 49.

The tandem image forming unit 20 includes the four image forming units 18C, 18M, 18Y, and 18K arranged in parallel. The image forming units 18C, 18M, 18Y, and 18K respectively form toner images in cyan, magenta, yellow, and black colors. The photoconductors 40C, 40M, 40Y, and 40K rotate in a rotating direction A. The chargers 70C, 70M, 70Y, and 70K, the development units 41C, 41M, 41Y, and 41K, and the cleaners 71C, 71M, 71Y, and 70K are respectively disposed around the photoconductors 40C, 40M, 40Y, and 40K. The chargers 70C, 70M, 70Y, and 70K respectively charge surfaces of the photoconductors 40C, 40M, 40Y, and 40K. The exposure unit 21 is disposed above the tandem image forming unit 20 and emits light (e.g., laser beams) onto the charged surfaces of the photoconductors 40C, 40M, 40Y, and 40K according to the image data created by the scanner 300 so as to form electrostatic latent images on the surfaces of the photoconductors 40C, 40M, 40Y, and 40K. The development units 41C, 41M, 41Y, and 41K respectively include developer carriers (not shown) for carrying developers (e.g., cyan, magenta, yellow, and black toner) and visualize the electrostatic latent images formed on the surfaces of the photoconductors 40C, 40M, 40Y, and 40K with the toner by applying alternating currents at positions where the development units 41C, 41M, 41Y, and 41K respectively oppose the photoconductors 40C, 40M, 40Y, and 40K. The alternating currents activate the toner and thereby narrow the charge amount distribution range of the toner for enhanced development. Thus, cyan, magenta, yellow, and black toner images are respectively formed on the surfaces of the photoconductors 40C, 40M, 40Y, and 40K.

The intermediate transfer belt 19 is formed in an endless belt-like shape and is disposed under the tandem image forming unit 20 in a manner that the intermediated transfer belt 19 opposes the photoconductors 40C, 40M, 40Y, and 40K. The intermediate transfer belt 19 is looped over the support rollers 15, 16, and 17. The first transferors 62C, 62M, 62Y, and 62K respectively oppose the photoconductors 40C, 40M, 40Y, and 40K via the intermediate transfer belt 19.

When the user presses the start button on the control panel of the image forming apparatus 10, a driving motor (not shown) drives and rotates one of the support rollers 15, 16, and 17. Such one of the support rollers 15, 16, and 17 rotates the other two of the support rollers 15, 16, and 17. Thus, the intermediate transfer belt 19 is rotated in a rotating direction B. The first transferors 62C, 62M, 62Y, and 62K respectively transfer and superimpose the cyan, magenta, yellow, and black toner images formed on the photoconductors 40C, 40M, 40Y, and 40K onto an outer circumferential surface of the rotating intermediate transfer belt 19. Thus, a color toner image is formed on the outer circumferential surface of the intermediate transfer belt 19.

The cleaners 71C, 71M, 71Y, and 71K respectively remove residual toner particles remaining on the surfaces of the photoconductors 40C, 40M, 40Y, and 40K after the cyan, magenta, yellow, and black toner images are transferred onto the outer circumferential surface of the intermediate transfer belt 19.

The registration roller 49 starts rotating to feed the recording sheet S conveyed through the conveyance path 48 or 53 to a nip formed between the second transferor 22 and the intermediate transfer belt 19 at a timing when the color toner image formed on the outer circumferential surface of the intermediate transfer belt 19 is properly transferred onto the recording sheet S. The second transferor 22 transfers the color toner image onto the recording sheet S.

The belt cleaner 23 removes residual toner particles remaining on the outer circumferential surface of the intermediate transfer belt 19 after the color toner image is transferred onto the recording sheet S.

The recording sheet S having the color toner image is conveyed to the fixing unit 25. In the fixing unit 25, heat and pressure are applied to the recording sheet S having the color toner image to fix the color toner image on the recording sheet S. The switching nail 55 is switched to guide the recording sheet S having the fixed color toner image toward the output roller 56. The output roller 56 feeds the recording sheet S having the fixed color toner image onto the output tray 57. To form a color toner image on the other side of the recording sheet S, the switching nail 55 is switched to guide the recording sheet S toward the reverse unit 28. In the reverse unit 28, the recording sheet S is reversed and fed toward the nip formed between the second transferor 22 and the intermediate transfer belt 19 again. The second transferor 22 transfers a color toner image onto the other side of the recording sheet S. Then, the recording sheet S is fed onto the output tray 57 via the fixing unit 25.

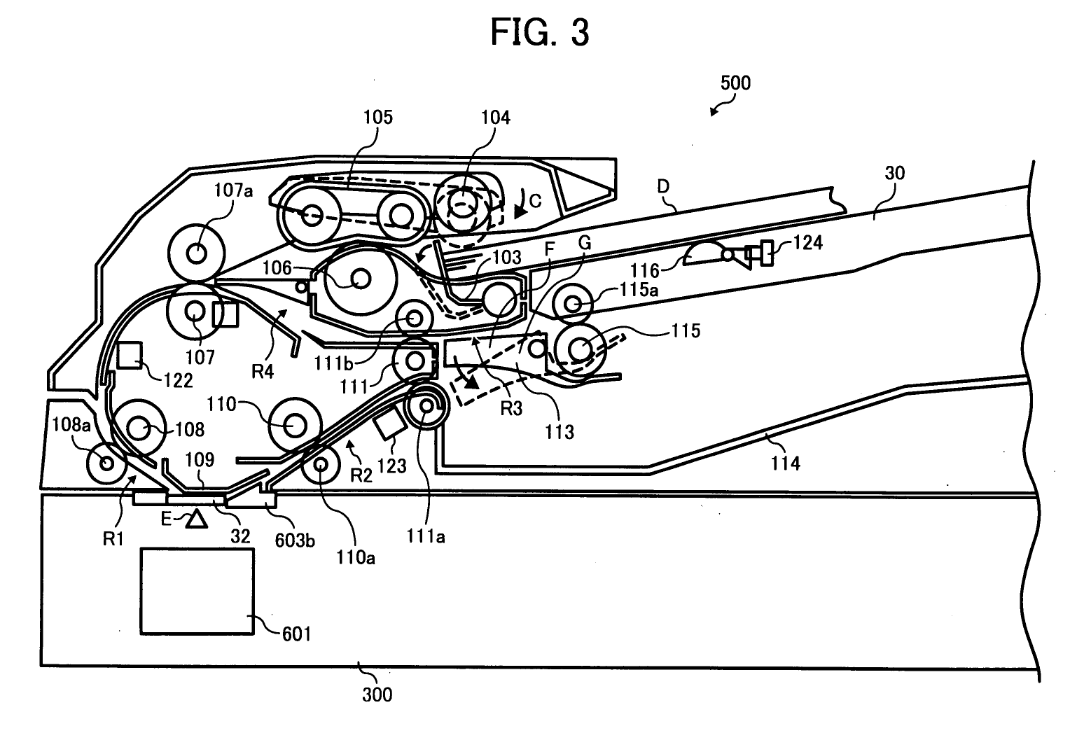

As illustrated in FIG. 3, the auto document feeder 500 further includes a stopper 103, a detecting feeler 116, an original tray sensor 124, a pickup roller 104, a feeder 105, a separator 106, correcting rollers 107 and 107a, a registration sensor 122, a first conveyance path R1, entrance rollers 108 and 108a, a registration sensor 122, exit rollers 110 and 110a, a scanning guide 109, a second conveyance path R2, an output roller 111, a lower driven roller 111a, an output sensor 123, an original output tray 114, a third conveyance path R3, a reverse roller 115, a reverse driven roller 115a, a fourth conveyance path R4, an upper driven roller 111b, and a switching nail 113. The scanner 300 further includes a guide 603b and a reader 601.

As illustrated in FIG. 3, the auto document feeder 500 is disposed on the scanner 300. The stopper 103 contacts and stops a foremost edge of an original sheet D set on the original tray 30. The detecting feeler 116 is partially disposed above the original tray 30 and moves when the original sheet D is set on the original tray 30. The original tray sensor 124 detects the movement of the detecting feeler 116 to recognize whether the original sheet D is set on the original tray 30 or not. The pickup roller 104 rotates in a rotating direction C (i.e., a sheet conveyance direction) to feed an uppermost original sheet D from the original tray 30. The feeder 105 further feeds the original sheet D fed by the pickup roller 104 toward the correcting rollers 107 and 107a. The separator 106 rotates in a rotating direction counter to the sheet conveyance direction to separate the uppermost original sheet D from other original sheets D, when a plurality of original sheets D are fed from the original tray 30, so as to feed only the uppermost original sheet D toward the correcting rollers 107 and 107a. The pickup roller 104 is driven by a solenoid (not shown). The feeder 105 and the separator 106 are driven by a driving motor (not shown) including a stepping motor, for example.

When the original sheet D contacts the correcting rollers 107 and 107a, the correcting rollers 107 and 107a correct the inclination of the original sheet D and feeds the original sheet D toward the entrance rollers 108 and 108a. The registration sensor 122 detects the foremost edge of the original sheet D fed by the correcting rollers 107 and 107a. The first conveyance path R1 is formed between a nip formed between the entrance rollers 108 and 108a and a nip formed between the exit rollers 110 and 110a. The entrance rollers 108 and 108a and the exit rollers 110 and 110a are driven by a driving motor (not shown) including a stepping motor, for example. The rotating speed of the exit roller 110 is by about 1 percent, for example, faster than the rotating speed of the entrance roller 108. When the original sheet D is sandwiched between the entrance rollers 108 and 108a and between the exit rollers 110 and 110a after being conveyed on the exposure glass 32 and picked up by the guide 603b, the original sheet D is stretched and does not contact the exposure glass 32. Thus, the original sheet D passes a scanning position E in a state that the original sheet D and the scanning guide 109 contact each other at a small area.

The reader 601 is disposed under the exposure glass 32 and scans an image on the original sheet D. The reader 601 includes the first traveler 33, the second traveler 34, the lens 35, and the scanning sensor 36 illustrated in FIG. 2. To scan the image on the original sheet D, the lamp and the mirror of the first traveler 33 move under the exposure glass 32 in the sheet conveyance direction or stop under the scanning position E. The lamp of the first traveler 33 emits light onto the original sheet D via the exposure glass 32. The mirror of the first traveler 33 deflects the light reflected by the original sheet D toward the second traveler 34. Mirrors of the second traveler 34 further deflect the light toward the lens 35. The lens 35 irradiates the deflected light into the scanning sensor 36. The scanning sensor 36 converts the light into an electric signal to create image data.

The second conveyance path R2 is formed between the nip formed between the exit rollers 110 and 110a and a nip formed between the output roller 111 and the lower driven roller 111a. The exit rollers 110 and 110a feed the original sheet D toward the output roller 111 via the second conveyance path R2. The output sensor 123 (e.g., an optical reflective sensor) is disposed upstream of the output roller 111 in the sheet conveyance direction and detects the original sheet D conveyed on the second conveyance path R2. When an image on one side of the original sheet D is scanned for one-sided copying, for example, the output roller 111 and the lower driven roller 111 a feed the original sheet D onto the original output tray 114.

The third conveyance path R3 is formed between the nip formed between the output roller 111 and the lower driven roller 111a and a nip formed between the reverse roller 115 and the reverse driven roller 115a. The fourth conveyance path R4 is formed between a nip formed between the output roller 111 and the upper driven roller 111b and a nip formed between the correcting rollers 107 and 107a. The switching nail 113 moves to guide the original sheet D to the third conveyance path R3 or the fourth conveyance path R4.

To scan an image on the other side of the original sheet D for duplex copying, for example, the switching nail 113 moves to a position G to guide the original sheet D fed by the output roller 111 and the lower driven roller 111a toward the nip formed between the reverse roller 115 and the reverse driven roller 115a. The output roller 111 and the reverse roller 115 are driven by a driving motor (not shown). Then, the switching nail 113 moves to a position F to guide the original sheet D fed by the reverse roller 115 and the reverse driven roller 115a toward a nip formed between the output roller 111 and the upper driven roller 111b. The output roller 111 and the upper driven roller 111b feed the original sheet D toward the correcting rollers 107 and 107a via the fourth conveyance path R4.

The following summary describes the operations of the auto document feeder 500 configured as described above. The user sets original sheets D on the original tray 30 in a manner that a first image on a front side of each of the original sheets D faces up. When the user presses the start button on the control panel of the image forming apparatus 10, a start signal is sent to the auto document feeder 500 and an uppermost sheet of the original sheets D is fed one by one. Specifically, when the user sets the original sheets D on the original tray 30, the foremost edges of the original sheets D contact the stopper 103 so that the original sheets D are properly aligned. A solenoid (not shown) rotates the pickup roller 104 in the rotating direction C in accordance with the start signal and lowers the pickup roller 104 to a position where the pickup roller 104 pressingly contacts the uppermost original sheet D. The rotating pickup roller 104 feeds the original sheets D toward a nip formed between the feeder 105 and the separator 106. The separator 106 separates the uppermost original sheet D from other original sheet D. The lowered pickup roller 104 is lifted when a predetermined time period H elapses after the pickup roller 104 starts feeding or when the registration sensor 122 detects the foremost edge of the original sheet D. When the pickup roller 104 is lifted, pressure is not applied by the pickup roller 104 to the original sheet D, thereby shortening a time period when an image on a back side of the uppermost original sheet D being fed scrubs an image on a front side of another original sheet D under the uppermost original sheet D being fed.

The predetermined time period H may be as short as possible to reduce stains caused by the uppermost original sheet D scrubbing another original sheet D under the uppermost original sheet D. When an image is formed on the front side of the original sheet D and is not formed on the back side of the original sheet D, the pickup roller 104 need not be lifted. The user may specify on the control panel of the image forming apparatus 10 whether to scan the front side of the original sheet D or to scan the front and back sides of the original sheet D.

The original sheet D separated by the separator 106 contacts the correcting rollers 107 and 107a which temporarily stop rotating. The correcting rollers 107 and 107a correct the inclination of the original sheet D. The correcting rollers 107 and 107a resume rotating to feed the original sheet D toward the entrance rollers 108 and 108a. The registration sensor 122 disposed near the entrance rollers 108 and 108a detects the foremost edge of the original sheet D so that image scanning properly starts when the foremost edge of the original sheet D passes the reader 601. When the registration sensor 122 does not detect the foremost edge of the original sheet D when a predetermined time period elapses after the separator 106 separates the uppermost original sheet D from other original sheet D, a controller (not shown) of the image forming apparatus 10 judges that the original sheet D is jammed.

The entrance rollers 108 and 108a feed the original sheet D toward the exposure glass 32. The reader 601 scans the front side of the original sheet D via the exposure glass 32. The exit rollers 110 and 110a feed the original sheet D toward the output roller 111 and the lower driven roller 111a.

When scanning the front side of the original sheet D only, the output roller 111 and the lower driven roller 111a feed the original sheet D onto the original output tray 114. When the output sensor 123 does not detect the foremost edge of the original sheet D when a predetermined time period elapses after the front side of the original sheet D is scanned or when the output sensor 123 does not detect a tail edge of the original sheet D when a predetermined time period elapses after the output sensor 123 detects the foremost edge of the original sheet D, the controller of the image forming apparatus 10 judges that the original sheet D is jammed. The switching nail 113 stops at the position F (i.e., a home position) to guide the original sheet D conveyed between the output roller 111 and the lower driven roller 111a to the original output tray 114.

When scanning the front and back sides of the original sheet D, a solenoid (not shown) moves the switching nail 113 from the position F to the position G when the output sensor 123 detects the foremost edge of the original sheet D or when a predetermined time period elapses after the registration sensor 122 detects the original sheet D. Thus, the switching nail 113 guides the original sheet D conveyed between the output roller 111 and the lower driven roller 111a on the third conveyance path R3 to the downstream of the switching nail 113.

The solenoid is released to return the switching nail 113 to position F when a predetermined time period elapses after the foremost edge of the original sheet D passes the output sensor 123. For example, such predetermined time period is equivalent to the time period needed for the tail edge of the original sheet D to reach the switching nail 113 after the foremost edge of the original sheet D passes the output sensor 123. After the switching nail 113 returns to the position F, the reverse roller 115 reverses its direction of rotation to feed the original sheet D toward the nip formed between the output roller 111 and the upper driven roller 111b. The output roller 111 and the upper driven roller 111b feed the original sheet D toward the correcting rollers 107 and 107a on the fourth conveyance path R4. When the original sheet D contacts the correcting rollers 107 and 107a, which temporarily stops rotating, the correcting rollers 107 and 107a correct the inclination of the original sheet D. The correcting rollers 107 and 107a resume rotation to feed the original sheet D toward the entrance rollers 108 and 108a. The entrance rollers 108 and 108a feed the original sheet D toward the scanning position E. The reader 601 scans the back side of the original sheet D passing the scanning position E.

To output the original sheet D onto the original output tray 114 in a state that the front side of the original sheet D faces down, the switching nail 113 moves to the position G. The original sheet D is conveyed on the second conveyance path R2 and the third conveyance path R3 to a position downstream of the switching nail 113. The original sheet D is temporarily held at the downstream of the switching nail 113 in a state that the back side of the original sheet D faces down. The switching nail 113 returns to the position F. The original sheet D is conveyed along the fourth conveyance path R4, the first conveyance path RI, and the second conveyance path R2 and is output onto the original output tray 114 in a state such that the front side of the original sheet D faces down.

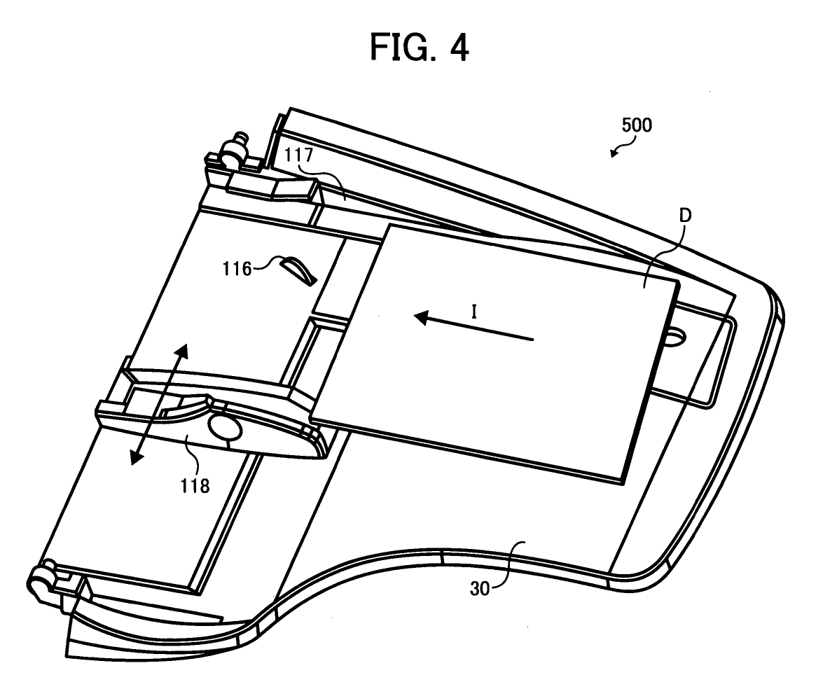

As illustrated in FIG. 4, the auto document feeder 500 further includes an original guide 117 and an adjuster 118. The original guide 117 is disposed along a direction I (i.e., the sheet conveyance direction) on one end of the original tray 30 in a direction perpendicular to the sheet conveyance direction. The adjuster 118 opposes the original guide 117 and moves in the direction perpendicular to the sheet conveyance direction. The adjuster 118 moves to hold an original sheet D together with the original guide 117. Namely, the original guide 117 and the adjuster 118 hold both side edges of the original sheet D in a width direction (i.e., the direction perpendicular to the sheet conveyance direction) of the original sheet D in accordance with the width of the original sheet D to prevent the original sheet D from being obliquely set on the original tray 30.

The detecting feeler 116 is disposed under the original tray 30, but partially protrudes above the original tray 30. The detecting feeler 16 functions as a detecting terminal for detecting whether the original sheet D is set on the original tray 30 or not. A predetermined space is provided between the protruding detecting feeler 116 and the original guide 117. The detecting feeler 116 is formed in a plate-like shape and includes a plane surface (hereinafter referred to as a “side surface” of the detecting feeler 116) along its longitudinal direction. The detecting feeler 116 is swingably disposed under the original tray 30, but a part of the detecting feeler 116 protrudes above the original tray 30. The side surface of the detecting feeler 116 is disposed substantially perpendicular to a top surface of the original tray 30 on which the original sheet D is set.

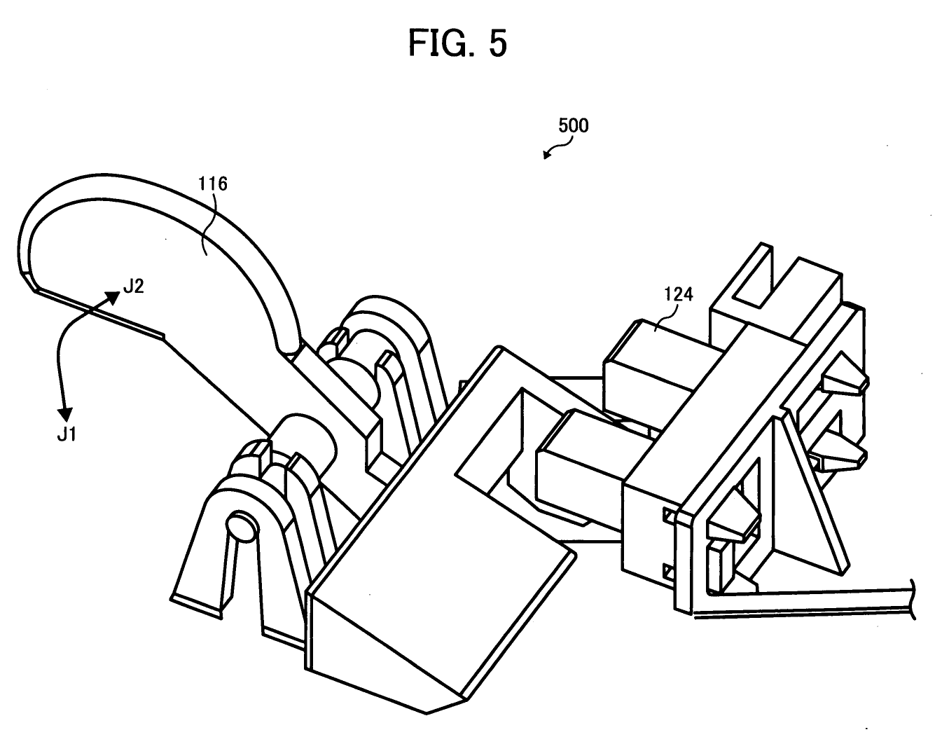

As illustrated in FIG. 5, the original tray sensor 124 is disposed near the detecting feeler 116. When the original sheet D is set on the original tray 30, the original sheet D pushes down the detecting feeler 116. The detecting feeler 116 swings in a direction J 1 and the entire plane surface of the detecting feeler 116 is buried under the top surface of the original tray 30. The original tray sensor 124 detects the swing in the direction J1 of the detecting feeler 116. Thus, the controller of the image forming apparatus 10 recognizes that the original sheet D is set on the original tray 30. When the original sheet D is fed out of the original tray 30, the detecting feeler 116 swings in a direction J2 and a part of the side surface of the detecting feeler 116 protrudes above the top surface of the original tray 30. The original tray sensor 124 detects the swinging in the direction J2 of the detecting feeler 116. Thus, the controller of the image forming apparatus 10 recognizes that the original sheet D is fed out of the original tray 30.

When the original sheet D is set on the original tray 30, the detecting feeler 116 swings in the direction J1 so that the entire plane surface of the detecting feeler 116 is buried under the top surface of the original tray 30. When the original sheet D is fed out of the original tray 30 and no original sheet D is set on the original tray 30, the detecting feeler 116 swings in the direction J2 so that a part of the side surface of the detecting feeler 116 protrudes above the top surface of the original tray 30. According to this non-limiting exemplary embodiment of the present invention, a virtual plane formed by the swings (i.e., tracks) of the detecting feeler 116 is defined as a swing plane of the detecting feeler 116.

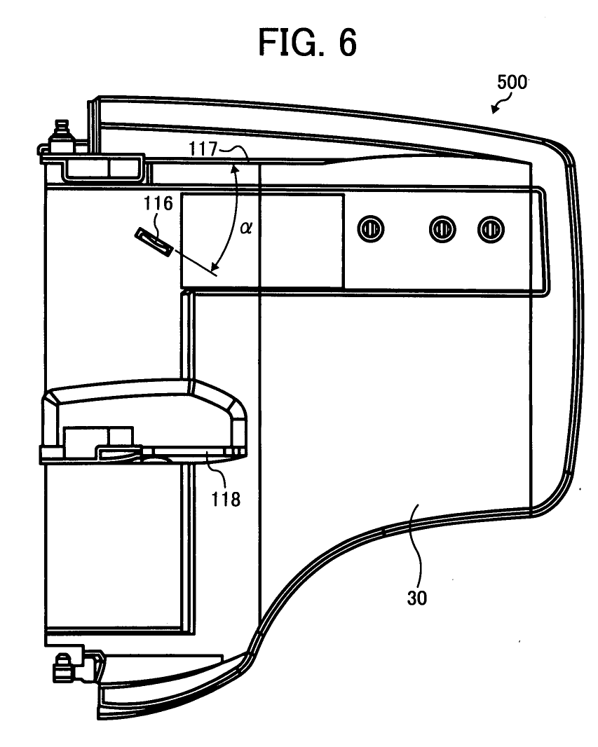

As illustrated in FIG. 6, the side surface of the detecting feeler 116 is disposed to form an angle α with respect to a longitudinal direction of the original guide 117, which is parallel to the sheet conveyance direction (i.e., the direction I in FIG. 4). The angle α is in a range of from about 30 degrees to about 60 degrees, for example. The side surface of the detecting feeler 116 disposed obliquely with respect to the longitudinal direction of the original guide 117 may increase a number of directions from which the original sheet D is inserted into the original tray 30. The original sheet D may be inserted into the original tray 30 from various directions. The user may move the adjuster 118 before or after setting the original sheet D onto the original tray 30.

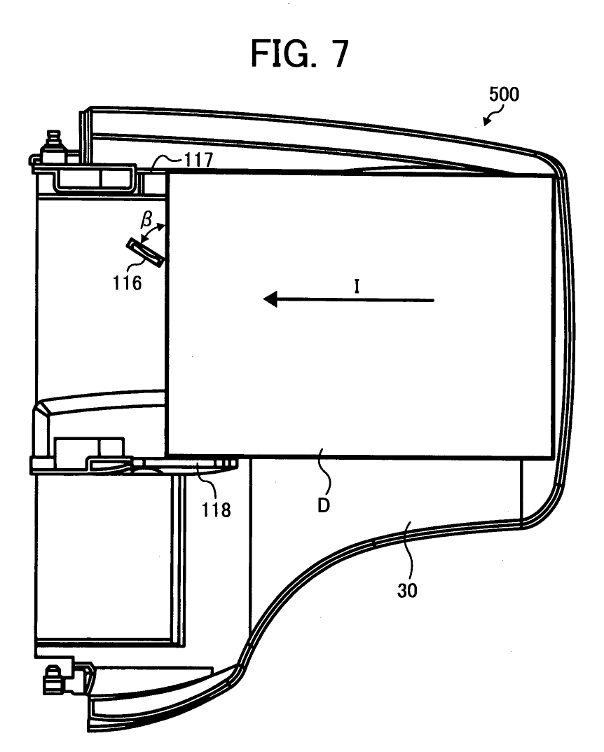

FIG. 7 illustrates the auto document feeder 500 in which the original sheet D is inserted into the original tray 30 in the direction I after the user moves the adjuster 118 in accordance with the size of the original sheet D. As illustrated in FIG. 7, the side surface of the detecting feeler 116 forms an angle β with respect to the foremost edge of the original sheet D in the direction I. The side surface of the detecting feeler 116 disposed obliquely with respect to the foremost edge of the original sheet D in the direction I may cause the original sheet D to be set onto the original tray 30 more smoothly than the side surface of the detecting feeler 116 disposed perpendicular to the foremost edge of the original sheet D in the direction I.

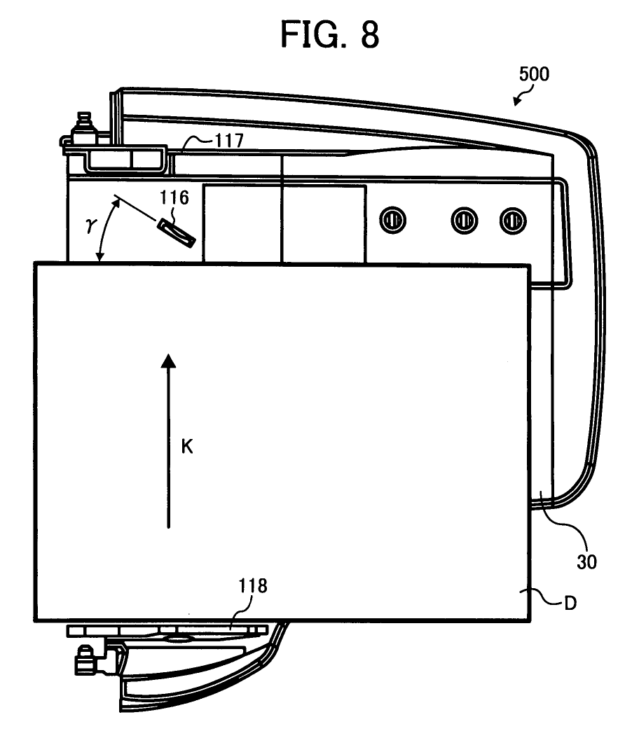

FIG. 8 illustrates the auto document feeder 500 in which the original sheet D is inserted into the original tray 30 in a direction K before the user moves the adjuster 118 in accordance with the size of the original sheet D. As illustrated in FIG. 8, the side surface of the detecting feeler 116 forms an angle γ with respect to the foremost edge of the original sheet D in the direction K. The side surface of the detecting feeler 116 disposed obliquely with respect to the foremost edge of the original sheet D in the direction K may cause the original sheet D to be set onto the original tray 30 more smoothly than the side surface of the detecting feeler 116 disposed perpendicular to the foremost edge of the original sheet D in the direction K.

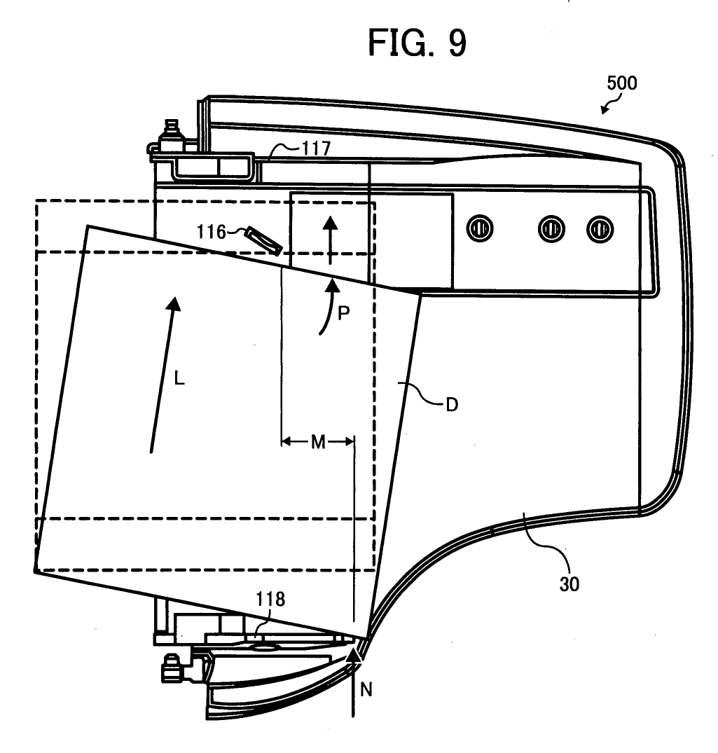

FIG. 9 illustrates the auto document feeder 500 in which the original sheet D is inserted into the original tray 30 in a direction oblique to the sheet conveyance direction (i.e., in direction L) before the user moves the adjuster 118 in accordance with the size of the original sheet D. As illustrated in FIG. 9, a distance M is provided between a line extending in the direction perpendicular to the sheet conveyance direction from one end of the protruding detecting feeler 116, which is closer to the adjuster 118, and a line extending in the direction perpendicular to the sheet conveyance direction from a tail end of the adjuster 118 in the sheet conveyance direction. The one end of the protruding detecting feeler 116 is disposed downstream of the tail end of the adjuster 1 18 in the sheet conveyance direction. When the user moves the adjuster 118 in a direction N, the original sheet D may be smoothly turned in a direction P without being disturbed by the detecting feeler 116. Thus, the original sheet D may be properly set onto the original tray 30 without being caught by the detecting feeler 116. The detecting feeler 116 may detect the original sheet D properly aligned by the adjuster 118 with improved precision.

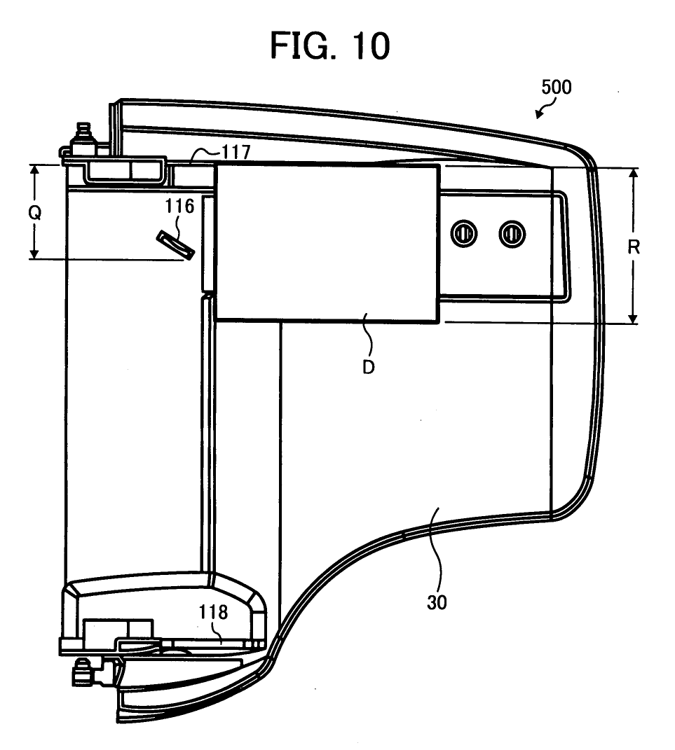

FIG. 10 illustrates the auto document feeder 500 in which an original sheet D having a smallest size such that the auto document feeder 500 may handle is inserted into the original tray 30. As illustrated in FIG. 10, a distance Q is provided between a line extending in the longitudinal direction of the original guide 117 and a line extending in the sheet conveyance direction from one end of the protruding detecting feeler 116 which is closer to the adjuster 118. The distance R is equivalent to a width of the original sheet D and is provided between a line extending in the longitudinal direction of the original guide 117 to which one side edge of the original sheet D contacts and a line extending in the sheet conveyance direction from the other side edge of the original sheet D facing the adjuster 118. Distance Q is shorter than distance R. Thus, the detecting feeler 116 may not miss a chance to detect the original sheet D. The head of the adjuster 118 in the sheet conveyance direction may be configured to move on the top surface of the original tray 30 in the direction perpendicular to the sheet conveyance direction so that the distance between the original guide 117 and the adjuster 118 opposing each other in the direction perpendicular to the sheet conveyance direction is longer than the width of the original sheet D. Thus, the original sheet D may be smoothly fed on the original tray 30.

According to this non-limiting exemplary embodiment of the present invention, the detecting feeler 116 is disposed to form the predetermined angle with respect to the original guide 117 on the top surface of the original tray 30. The original sheet D may be smoothly inserted into the original tray 30 from various directions, resulting in enhanced usability of the auto document feeder 500. The detecting feeler 116 may not catch the original sheet D while the original sheet D is inserted into the original tray 30. Thus, the detecting feeler 116 may not damage the original sheet D, preventing the original sheet D from being wasted. The original guide 117 may guide the original sheet D to be fed in a uniform direction. Thus, the original sheet D may stably access the detecting feeler 116, resulting in stable operations of the auto document feeder 500.

The present invention has been described above with reference to specific exemplary embodiments. Note that the present invention is not limited to the details of the embodiments described above, but various modifications and enhancements are possible without departing from the spirit and scope of the invention. It is therefore to be understood that the present invention may be practiced otherwise than as specifically described herein. For example, elements and/or features of different illustrative exemplary embodiments may be combined with each other and/or substituted for each other within the scope of the present invention.

The present application is based on and claims priority to Japanese patent applications No. 2005-208326 filed on Jul. 19, 2005 and No. 2006-044940 filed on Feb. 22, 2006 in the Japan Patent Office, the entire contents of which are hereby incorporated herein by reference.

What is claimed is:

1. An image forming apparatus, comprising:
an auto document feeder configured to feed an original sheet having an image and including,
an original tray configured to load the original sheet having the image, and
a detecting mechanism configured to detect the original sheet set on the original tray and including, a terminal including a plane surface disposed to form a predetermined angle with respect to a sheet conveyance direction;
a scanner configured to scan the image on the original sheet fed by the auto document feeder to create image data;
a paper tray configured to supply a recording medium; and
an image forming mechanism configured to form an image on the recording medium supplied from the paper tray with a developer according to the image data created by the scanner.

2. The image forming apparatus according to claim 1,
wherein the terminal is formed in a plate-like shape and a part of the terminal protrudes above a top surface of the original tray, on which the original sheet is set, and swings when pressed by the original sheet set on the original tray.

3. The image forming apparatus according to claim 2,
wherein the auto document feeder further includes a guide for guiding the original sheet to be set on the original tray, and
wherein the plane surface of the terminal is formed along a longitudinal direction of the terminal and is disposed so as to be substantially perpendicular to the top surface of the original tray so as to form a predetermined angle with respect to the guide.

4. The image forming apparatus according to claim 2,
wherein the terminal includes a swing plane which is virtually formed by the swing of the terminal and forms a predetermined angle with respect to the guide.

5. The image forming apparatus according to claim 3,
wherein the predetermined angle is in a range of from about 30 degrees and to about 60 degrees.

6. The image forming apparatus according to claim 3,
wherein the auto document feeder further includes an adjuster opposing the guide and configured to be movable to adjust a distance between the adjuster and the guide which is not movable.

7. The image forming apparatus according to claim 6,
wherein a head of the adjuster in a sheet conveyance direction is movable to a position where the distance between the adjuster and the guide is longer than a width of the original sheet set on the original tray.

8. The image forming apparatus according to claim 7,
wherein the terminal protrudes above the top surface of the original tray at a position upstream of the head of the adjuster and downstream of a tail of the adjuster in the sheet conveyance direction.

9. The image forming apparatus according to claim 3,
wherein a distance between the guide and the protruding terminal on the top surface of the original tray is shorter than a width of the original sheet set on the original tray.

10. An auto document feeder for feeding an original sheet having an image, comprising:
an original tray configured to load the original sheet having the image; and
a detecting mechanism configured to detect the original sheet set on the original tray and including,
a terminal including a plane surface disposed to form a predetermined angle with respect to a sheet conveyance direction.

11. The auto document feeder according to claim 10,
wherein the terminal is formed in a plate-like shape and a part of the terminal protrudes above a top surface of the original tray, on which the original sheet is set, and swings when pressed by the original sheet set on the original tray.

12. The auto document feeder according to claim 11, further comprising:
a guide for guiding the original sheet to be set on the original tray,
wherein the plane surface of the terminal is formed along a longitudinal direction of the terminal and is disposed substantially perpendicular to the top surface of the original tray to form a predetermined angle with respect to the guide.

13. The auto document feeder according to claim 11,
wherein the terminal includes a swing plane which is virtually formed by the swing of the terminal and forms a predetermined angle with respect to the guide.

14. The auto document feeder according to claim 12,
wherein the predetermined angle is in a range of from about 30 degrees and to about 60 degrees.

15. The auto document feeder according to claim 12, further comprising:
an adjuster opposing the guide and configured to be movable to adjust a distance between the adjuster and the guide which is not movable.

16. The auto document feeder according to claim 15,
wherein a head of the adjuster in a sheet conveyance direction is movable to a position where the distance between the adjuster and the guide is longer than a width of the original sheet set on the original tray.

17. The auto document feeder according to claim 16,
wherein the terminal protrudes above the top surface of the original tray at a position upstream of the head of the adjuster and downstream of a tail of the adjuster in the sheet conveyance direction.

18. The auto document feeder according to claim 12,
wherein a distance between the guide and the protruding terminal on the top surface of the original tray is shorter than a width of the original sheet set on the original tray.

19. An image forming apparatus, comprising:
means for feeding an original sheet having an image and including,
means for loading the original sheet having the image, and
means for detecting the original sheet set on the means for loading and including,
means for swinging to smoothly receive a collision with the original sheet and including a plane surface disposed to form a predetermined angle with respect to a sheet conveyance direction;
means for scanning the image on the original sheet fed by the means for feeding to create image data;
means for supplying a recording medium; and
means for forming an image on the recording medium supplied from the means for supplying with a developer according to the image data created by the means for scanning.
